(19) United States
(12) Patent Application Publication
(10) Pub. No.: US 2021/0043903 A1
(43) Pub. Date: Feb. 11, 2021

(54) MICROPOROUS MEMBRANES, BATTERY SEPARATORS, AND METHODS FOR MAKING AND USING THE SAME

(71) Applicant: Celgard, LLC, Charlotte, NC (US)

(72) Inventor: Masaaki Okada, Charlotte, NC (US)

(21) Appl. No.: 16/977,481

(22) PCT Filed: Mar. 1, 2019
(86) PCT No.: PCT/US2019/020183

§ 371 Date: Sep. 2, 2020

Related U.S. Application Data
(60) Provisional application No. 62/637,576, filed on Mar. 2, 2018.

(51) Int. Cl. H01M 2/14; B01D 67/00; B01D 69/12; B01D 71/26; B01D 69/02; H01M 2/16; H01M 10/0525; B32B 27/32; B32B 27/08; B32B 37/18; B32B 38/00; B29C 48/00; B29D 99/00; B29C 55/14; B29C 48/08

(52) U.S. Cl. CPC H01M 2/145; B29L 2031/14; B01D 67/0086; B01D 67/002; B01D 69/12; B01D 71/26; B01D 69/02; H01M 2/1653; H01M 2/1686; H01M 10/0525; B32B 27/32; B32B 27/08; B32B 37/182; B32B 38/0012; B29C 48/0021; B29D 99/005; B29C 55/143; B29C 48/0018; B29C 48/08; B01D 2325/24; B32B 2038/0028; B32B 2038/0064; B32B 2250/242; B32B 2307/581; B32B 2307/54; B32B 2307/204; B32B 2255/20; B32B 2255/10; B32B 2305/026; B32B 2309/02; B32B 2309/105; B32B 2323/04; B32B 2323/10; B32B 2457/10; B01D 67/0027

(57) ABSTRACT

Disclosed herein is an improved membrane, separator and/or method for forming a multilayer microporous membrane for use in an improved battery separator, particularly a battery separator for a lithium ion secondary battery. Also disclosed herein is the multilayer microporous membrane formed by this method, which has properties that compete with or exceed those of wet process, coated or uncoated, membranes that are also useable in battery separators. Also disclosed are battery separators comprising the multilayer microporous membrane and batteries, vehicles, or devices comprising the separators. The method may comprise at least the following steps: (1) forming a stretched first non-porous precursor film that has pores due to the stretching of a first non-porous precursor film; (2) separately forming a second stretched non-porous precursor film that has pores due to the stretching of a second non-porous precursor film; and then (3) laminating the stretched first non-porous precursor and the stretched second non-porous precursor.

### FIELD

This application is directed to new and/or improved microporous membranes, separator membranes, battery separators including said microporous membranes, cells or batteries including the separators, and/or methods for making and/or using new and/or improved microporous membranes and battery separators comprising said microporous membranes. For example, the new and/or improved microporous membranes, and battery separators comprising the same, preferably have a better balance of desirable properties than prior microporous membranes. Also, the new and/or improved methods produce microporous membranes, and battery separators comprising the same, having a better balance of desirable properties than prior microporous membranes. The new and/or improved microporous membranes and battery separators including said microporous membranes are preferably dry process microporous membranes and battery separators including said microporous membranes and are competitive with or better than coated or un-coated wet process microporous membranes and battery separators including coated or un-coated wet process microporous membranes, respectively.

### BACKGROUND

Historically, wet process microporous membranes have had some preferred properties compared to certain dry process membranes, even including certain past Celgard® dry process membranes. These preferred properties sometimes included higher puncture strength, better thickness uniformity, and/or higher dielectric breakdown values. However, there are drawbacks to wet process microporous membranes, including the fact that they have higher manufacturing cost and are less environmentally friendly due to the use of oils and organic solvents in processing of these wet membranes. Another reason wet process membranes are more costly than dry process membranes is because they cannot be used uncoated like certain dry process membranes can. This is because they are, unlike dry process membranes, susceptible to oxidation due to polyethylene being exposed to the high voltage in lithium ion batteries. Almost all wet process membranes are made with polyethylene resin, which oxidizes. In some dry process membranes this problem is solved by adding outer layers of polypropylene to the membrane.

Several attempts, including some successful attempts, to form dry process membranes that are competitive with or better than wet process membranes, e.g., in their strength, thickness uniformity, and dielectric breakdown have been made. See, for example, International Patent Application Nos. PCT/US2017/061277 and PCT/US2017/060377, both of these applications are fully incorporated herein by reference. The separators in these applications compete with or are better than wet process membranes. However, each process forms membranes having some or many much improved properties and some that still need some improvement. The improved properties and those that need improvement are different for each process. Depending on which properties are important to the consumer or battery maker, one membrane may be desired over another. The desired properties depend on several factors such as how the membrane is used. For example, if the membrane is used for a battery, how the battery is manufactured and the type of battery being manufactured matter.

Many dry process membranes used today are coated, e.g., to improve shrinkage and/or puncture strength, but this is an extra step and layer.

Thus, there is a need for new dry process membranes having improved properties that meet each individual customers needs and/or compete with or surpass more costly (environmentally and monetarily) wet process membranes. There is also a desire to form an uncoated dry process membrane that has the strength of a coated membrane, without needing to be coated.

### SUMMARY

In accordance with at least selected embodiments, aspects or objects, at least some of the desires, needs or problems described above may be addressed by this application, disclosure or invention, and/or there may be provided or described herein possibly preferred dry process microporous membranes that compete with or surpasses wet process membrane performance. Also, the possibly preferred membrane described herein may not have to be coated to achieve, for example, reduced shrinkage.

This application or invention is directed to new and/or improved microporous membranes, separator membranes, battery separators including said microporous membranes, cells or batteries including the separators, and/or methods for making and/or using new and/or improved microporous membranes and battery separators comprising said microporous membranes. For example, the new and/or improved microporous membranes, and battery separators comprising the same, preferably have a better balance of desirable properties than prior microporous membranes. Also, the new and/or improved methods produce microporous membranes, and battery separators comprising the same, having a better balance of desirable properties than prior microporous membranes. The new and/or improved microporous membranes and battery separators including said microporous membranes are preferably dry process microporous membranes and battery separators including said microporous membranes and are competitive with or better than coated or un-coated wet-process microporous membranes and battery separators including coated or un-coated wet-process microporous membranes, respectively.

In accordance with at least certain embodiments, aspects or objects, this application or invention is directed to new and/or improved microporous membranes, separator membranes, battery separators including said microporous membranes, cells or batteries including the separators, and/or methods for making and/or using new and/or improved microporous membranes and battery separators comprising said microporous membranes. For example, the new and/or improved microporous membranes, and battery separators comprising the same, preferably have a better balance of desirable properties than prior microporous membranes. Also, the new and/or improved methods produce microporous membranes, and battery separators comprising the same, having a better balance of desirable properties than prior microporous membranes. The new and/or improved microporous membranes and battery separators including said microporous membranes are preferably dry process microporous membranes and battery separators including said microporous membranes and are competitive with or better than coated or un-coated wet process microporous membranes and battery separators including coated or un-coated wet process microporous membranes, respectively.

In one aspect, a method for forming a multilayer microporous membrane is described herein. In some embodiments, the method comprises a step of extruding a first resin mixture to form a first nonporous precursor film and then stretching the first nonporous precursor film in the machine direction (MD) to form pores. Thus, the MD stretched first non-porous precursor film has pores or is porous or microporous. Separately, the method comprises a step of extruding a second resin mixture to form a second nonporous precursor film and then stretching the second nonporous precursor film in the machine direction (MD) to form pores. Thus, the MD stretched second non-porous precursor film also has pores or is porous or microporous. Then, the method includes a step of laminating the MD stretched first precursor and the MD stretched second precursor.

In some embodiments, the first resin mixture comprises at least one of a polypropylene resin and a resin having a melt temperature equal to or greater than 140 degrees centigrade and equal to or less than 330 degrees centigrade. In some embodiments, the first resin mixture comprises at least one of a polypropylene resin and a resin having a melt temperature equal to or greater than that of polypropylene and the second resin mixture comprises at least one of a polyethylene resin and a resin having a melt temperature equal to or lower than 140 degrees centigrade, preferably equal to or lower than 135 degrees centigrade.

In some embodiments, at least one of the first nonporous film and the second nonporous precursor film is a co-extruded film formed by co-extruding at least one other resin mixture along with the first or second resin mixture. The other resin mixture may be the same or different that the first or second resin mixture.

After forming the first nonporous precursor, in some embodiments, the first nonporous precursor may be sequentially or simultaneously in the machine direction (MD) and in the transverse direction (TD) prior to laminating. The MD and TD stretched first non-porous precursor formed this way has pores or is porous or microporous. In some preferred embodiments of this method, the first resin mixture, which is extruded to form the first nonporous precursor, comprises at least one of a polypropylene resin and a resin having a melt temperature equal to or greater than 140 degrees centigrade and equal to or lower than 330 degrees centrigrade.

In other embodiments, after forming the MD stretched first nonporous precursor, the MD stretched first nonporous precursor is calendered prior to laminating. In some embodiments, this calendering is performed after MD and TD stretching, simultaneously or sequentially, the first non-porous precursor. For example, the first nonporous precursor may be MD stretched and then TD stretched or simultaneously MD and TD stretched, and then, the MD and TD stretched first non-porous precursor may be calendered prior to laminating. The MD and TD stretched and calendered first non-porous precursor also has pores or is porous or microporous. In some preferred embodiments of this method, the first resin mixture, which is extruded to form the first nonporous precursor, comprises at least one of a polypropylene resin and a resin having a melt temperature equal to or greater than 140 degrees centigrade and equal to or lower than 330 degrees centigrade.

In other embodiments, calendering may be performed after the lamination step. For example, calendering may be performed after laminating an MD stretched first nonporous precursor and an MD stretched second nonporous precursor. In other embodiments, calendering may be performed after laminating an MD and TD stretched first nonporous precursor and an MD stretched second nonporous precursor. In further embodiments, calendering may be performed after laminating an MD and TD stretched and calendered first nonporous precursor and an MD stretched second nonporous precursor. In this embodiment, two calendering steps are performed. Calendering of the MD and TD stretched first nonporous precursor prior to laminating and calendering of the laminate of the MD and TD stretched and calendered first nonporous precursor and the MD stretched second nonporous precursor.

In some embodiments, at least one of the MD stretched first nonporous precursor and the MD stretched second nonporous precursor are treated prior to laminating to improve adhesion. In other embodiments, at least one of the MD and TD stretched first nonporous precursor and the MD stretched second nonporous precursor are treated after stretching, but prior to laminating, to improve adhesion. In further embodiments, at least one of the MD and TD stretched and calendered first nonporous precursor and the MD stretched nonporous second precursor are treated after stretching or stretching and calendering, but prior to laminating, to improve adhesion. The treatment for the precursors is at least one selected from the group consisting of pre-heating, corona treatment, plasma treatment, roughening, UV irradiation, excimer irradiation, or application of an adhesive.

In some embodiments, the multilayer microporous membrane formed by the method comprises the first MD stretched nonporous precursor film, which comprises at least one of a polypropylene resin and a resin having a melt temperature equal to or greater than 140 degrees centigrade and equal to or lower than 330 degrees centigrade, i.e., between 140 and 330 degrees centigrade; the second MD stretch nonporous precursor film, which comprises a polyethylene resin; and a third film comprising at least one of a polypropylene resin and a resin having a melt temperature equal to or greater than 140 degrees centigrade and equal to or lower than 330 degrees centigrade, wherein the films are laminated together in that order. The third film may be formed by extruding (or co-extruding) a resin mixture comprising at least one of a polypropylene resin and a resin having a melt temperature equal to or greater than 140 degrees centigrade and equal to or lower than 330 degrees centigrade to form a third nonporous precursor and then stretching the third nonporous precursor in the machine direction (MD) to form pores. In other embodiments, the third nonporous precursor may be MD and TD stretched, sequentially or simultaneously, and in other embodiments, the third nonporous precursor may be MD and TD stretched, sequentially or simultaneously, and then calendered. In other embodiments, it may be calendered then coated, or coated then calendered, or calendered, coated, then calendered again. In still other embodiments, the third film may be formed by extruding a resin mixture comprising a polyethylene resin to form the third non-porous precursor and then stretching the third nonporous precursor in the machine direction (MD) to form pores.

In some embodiments, the multilayer microporous membrane is a bilayer microporous membrane. For example, it may be formed by laminating only the first MD stretched nonporous precursor and the second MD stretched nonporous precursor. In other embodiments, the multilayer microporous membrane is a trilayer microporous membrane. For example, it may be formed by laminating the first MD stretched nonporous precursor and the second MD stretched nonporous precursor with a third stretched nonporous precursor.

In another aspect, a multilayer microporous membrane is disclosed herein. The microporous membrane may be a multilayer microporous membrane formed by any method described herein. In some embodiments, the multilayer microporous membrane is one having at least one of the following properties: a) a JIS Gurley between 50 and 400, between 100 and 400, between 150 and 400, between 100 and 300, or preferably between 100 and 200;b) a puncture strength between 150 gf and 600 gf, between 300 gf and 600 gf, between 320 gf and 600 gf, more preferably between 380 gf and 600 gf, and most preferably between 400 gf and 600 gf or more;c) an MD strength above 500 kg/cm², above 600 kg/cm², above 700 kg/cm² and preferably above 1,000 kg/cm²; d) A TD strength above 300 kg/cm², above 350 kg/cm², preferably above 500 kg/cm², and most preferably above 600 kg/cm²; e) an MD elongation preferably equal to or above 30%, equal to or above 40%, equal to above 50%, or more preferably above 100%; f) a TD elongation preferably equal to or above 30%, or 40%, or 50%, or 60% or more preferably equal to or above 70%; g) an MD shrinkage at least one of 105° C., 120° C., 130° C., or 140° C. that is below 25%, more preferably below 20%, even more preferably below 15%; and most preferably 10% or less; h) a TD shrinkage at least one of 105° C., 120° C., 130° C., or 140° C. that is below 15%, preferably below 10%, and most preferably below 5%; i) reduced splittiness; j) good uniformity, and as a result, a higher minimum dielectric breakdown value; k) a thickness of 25 microns or less, preferably 20 microns or less, most preferably 15 microns or less; and l) reduced moisture. The membrane may have two or more, three or more, four or more, five or more, six or more, seven or more, eight or more, nine or more, ten or more, eleven or more, or all twelve of the foregoing properties.

With regard to the reduced moisture, this property is observed due to the fact that the membranes described herein do not need to be coated. Particularly, they do not need to be coated with a ceramic coating, which adsorbs moisture (water) from the atmosphere. The membranes described herein may have a moisture content as low as less than or equal to 1500 ppm when measured by the Karl Fischer titration method. Preferably, the moisture content is less than 1000 ppm, less than 900 ppm, less than 800 ppm, less than 700 ppm, less than 600 ppm, less than 400 ppm, less than 300 ppm, and most preferably less than 200 ppm.

In another aspect, a battery separator is disclosed. The battery separator may comprise at least one of the multilayer microporous membranes described herein. The battery separator may comprise at least one membrane that is coated on one or two sides thereof. In some embodiments, the at least one membrane is coated on two sides that are opposite to one another. In some embodiments, the at least one membrane is coated on only one side. In some embodiments, the at least one membrane is not coated with a ceramic coating.

In other aspects, it may be calendered then coated (or treated), or coated then calendered, or calendered, coated, then calendered again.

In yet another aspect, a secondary lithium ion battery comprising any battery separator described herein is disclosed.

In still another aspect, a composite comprising any battery separator described herein in direct contact with an electrode for a secondary lithium ion battery or cell is disclosed.

In another aspect, a vehicle or device comprising at least one battery or cell including any separator as described herein is disclosed.

### BRIEF DESCRPTION OF THE DRAWINGS

FIG. 1 is a schematic drawing of some processes disclosed herein.

FIG. 2 is a schematic drawing of one-side and two-side coated microporous membranes disclosed herein.

FIG. 3 is a schematic drawing of a lithium-ion battery.

FIG. 4 includes cross-section SEMs of microporous membranes according to at least some embodiments described herein.

### DETAILED SUMMARY

Embodiments described herein can be understood more readily by reference to the following detailed description, examples, and figures. Elements, apparatus, and methods described herein, however, are not limited to the specific embodiments presented in the detailed description, examples, and figures. It should be recognized that these embodiments are merely illustrative of the principles of the present invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10,” “from 5 to 10,” or “5-10” should generally be considered to include the end points 5 and 10.

Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

Disclosed herein is a new and improved method for forming a multilayer microporous membrane that may be used as or as part of a battery separator for, for example, a lithium ion battery. The method is preferably a “dry” method, meaning that a solvent is not used in the extrusion steps of the new and improved method. For example, the “dry” process may be a Celgard® dry process. The multilayer microporous membrane formed by the method is competitive with or better than a coated or uncoated wet process membrane. A battery separator comprising the microporous membrane herein is also disclosed. Also disclosed are a lithium ion secondary battery and vehicle or device comprising these separators.

Method

The method described herein may comprise, consist of, or consist essentially of the following steps: (1) forming a first non-porous precursor by extruding a first resin mixture and then stretching the first non-porous precursor film in the machine direction (MD) to form a stretched first non-porous precursor film; (2) separately forming a second non-porous precursor film and then stretching the non-porous precursor film in the machine direction (MD) to form a second stretch non-porous precursor film; and then (3) laminating the stretched first non-porous precursor and the stretched second non-porous precursor. Step (2) may be performed before, after, or simultaneously with step (1). In a preferred embodiment, the stretched first non-porous precursor is formed by MD and TD stretching, either sequentially or simultaneously, the first non-porous precursor film. For example, the first non-porous precursor may be MD stretched and then TD stretched or simultaneously MD and TD stretched. In another preferred embodiment, the stretched first non-porous precursor film may be formed in step (1) by MD and TD stretching, as described above, and then calendering the first non-porous precursor film. Then, the MD and TD stretched and calendered first non-porous precursor may be laminated to the MD stretched second non-porous precursor. In a further embodiments, a calendering step (4) may be performed after the lamination step. In other preferred embodiments, a treatment step (5) may be performed on either or both of the MD stretched first non-porous precursor film formed in step (1), the MD stretched second non-porous precursor film formed in step (2), the MD and TD stretched first non-porous precursor film formed in step 1, or the MD and TD stretched and calendered first non-porous precursor film formed in step (1). The treatment step (5) is performed after steps (1) and/or (2), but before the lamination step (3). For example, in some embodiments, the treatment step may be performed on the stretched first non-porous precursor film after step (1), but before the second stretched non-porous precursor film is formed in step (2). The treatment step, in some embodiments, is performed to improve adhesion between the MD stretched first non-porous precursor film, the MD and TD stretched non-porous precursor film, or the MD and TD stretched and calendered non-porous precursor film and the stretched second non-porous precursor film.

In other aspects, it may be calendered then coated (or treated), or coated then calendered, or calendered, coated, then calendered again.

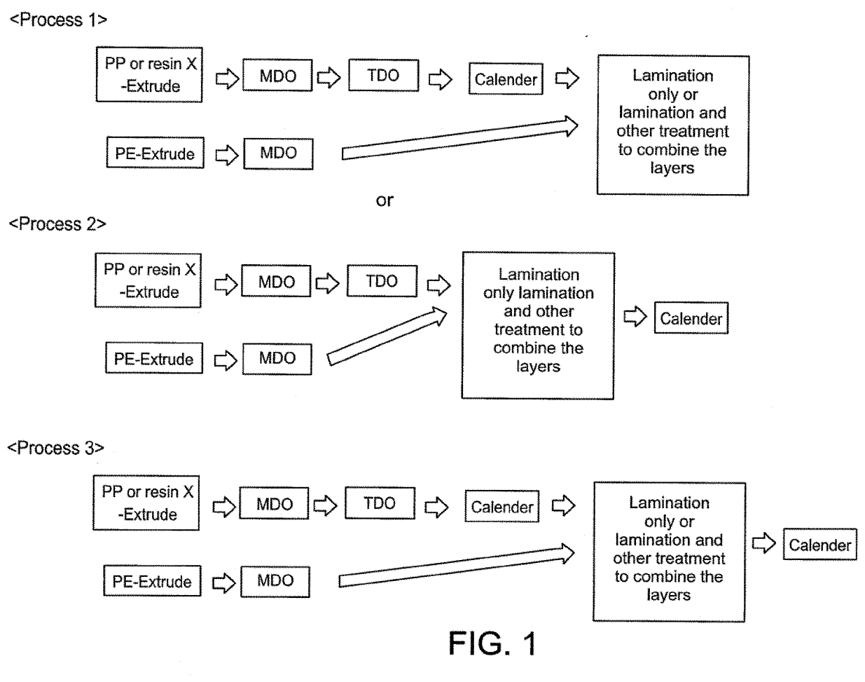

Some examples of methods or processes described herein are shown in FIG. 1. In FIG. 1, MDO is MD stretching, TDO is TD stretching, and resin X is a resin having a melting point equal to or above 140 degrees centigrade and equal to or less than 330 degrees centigrade. In FIG. 1. PE may be extruded alone or with a resin having a melt temperature less than 140 degrees centigrade, preferably less than 135 degrees centigrade. Alternatively, instead of PE, a resin having a melt temperature less than 140 degrees centigrade, preferably less than 135 degrees centigrade.

(1) Forming a Stretched or Stretched and Calendered First Non-Porous Precursor Film

The step of forming the stretched (MD or MD and TD) or stretched (MD or MD and TD) and calendered first non-porous precursor film is not so limited. The step may comprise, consist of, or consist essentially of extruding a first resin mixture to form a non-porous precursor film, and then, stretching (MD or MD and TD) the non-porous precursor film or stretching (MD or MD and TD) and calendering the non-porous precursor film.

The extrusion step is not so limited. In preferred embodiments, the extrusion step is a dry extrusion step meaning the resin mixture is extruded without an oil or solvent. In other preferred embodiments, the extrusion step may involve co-extrusion where two or more resin mixtures are extruded to form a bi-layer, trilayer, or four or more layer non-porous precursor film. The two or more resin mixtures may each be the same or some or all of them may be different.

The resin mixture used in step (1) is not so limited and may comprise, consist of, or consist essentially of any extrudable resin, particularly a resin that is extrudable as part of a dry process such as the Celgard® dry process. In some preferred embodiments, the resin mixture used in step (1) comprises, consists of, or consists essentially of a polypropylene or a high melt temperature resin amenable to dry processing such as the Celgard® dry process. For example, the high melt temperature resin may be any one of PMP, a polyester like PET, POM, PA, PPS, PEEK, PTFE, or PBT.

The MD stretching is not so limited. Machine direction (MD) stretch may be conducted as a single step or multiple steps, and as a cold stretch, as a hot stretch, or both (e.g., in multistep embodiments). In one embodiment, cold stretching may be carried out at <Tm−50° C., where Tm is the melting temperature of the polymer in the membrane precursor, and in another embodiment, at <Tm−80° C. In one embodiment, hot stretching may be carried out at <Tm−10° C. In one embodiment, total machine direction stretching may be in the range of 50-500% (i.e., .5 to 5×), and in another embodiment, in the range of 100-300% (i.e., 1 to 3×).This means the width (in the MD direction) of the membrane precursor increases by 50 to 500% or by 100 to 300% compared to the initial width, i.e., before any stretching, during MD stretching. In some preferred embodiments, the membrane precursor is stretched in the range of 180 to 250% (i.e., 1.8 to 2.5×). During machine direction stretch, the precursor may shrink in the transverse direction (conventional).

In some preferred embodiments, TD and/or MD relaxation is performed during or after, preferably after, the MD stretch or during or after, preferably after, at least one step of the MD stretch process if it is multiple steps, including 10 to 90% MD and/or TD relax, 20 to 80% MD and/or TD relax, 30 to 70% MD and/or TD relax, 40 to 60% MD and/or TD relax, at least 20% MD and/or TD relax, 50%, etc. Not wishing to be bound by any particular theory, it is believed that relax may reduce “necking” resulting from MD stretching and/or help with MD shrinkage of the final product.

The machine direction (MD) stretching, particularly the initial or first MD stretching forms pores in the non-porous precursors. MD tensile strength of the uniaxially-stretched (i.e., MD stretched only) membrane precursor is high, e.g., 1500 kg/cm² and above or 200 kg/cm² or above. However, TD tensile strength and puncture strength of these uniaxially-stretched membrane precursors are not optimal.

The TD stretching is also not so limited and can be performed in any manner that is not contrary to the stated goals herein. The transverse direction stretching may be conducted as a cold step, as a hot step, or a combination of both (e.g., in a multi-step TD stretching described herein below). In one embodiment, total transverse direction stretching may be in the range of 100-1200%, in the range of 200-900%, in the range of 450-600%, in the range of 400-600%, in the range of 400-500%, etc. In one embodiment, a controlled machine direction relax may be in a range from 5-80%, and in another embodiment, in the range of 15-65%. In one embodiment, TD may be carried out in multiple steps. During transverse direction stretching, the precursor may or may not be allowed to shrink in the machine direction. In some embodiments, TD stretching may be performed with MD relax, with TD relax, or with MD and TD relax. Relax can occur during, before, or after stretching.

For example, TD stretching may be performed with or without machine direction (MD) and/or transverse direction (TD) relax. In some preferred embodiments, MD and/or TD relax is performed, including 10 to 90% MD and/or TD relax, 20 to 80% MD and/or TD relax, 30 to 70% MD and/or TD relax, 40 to 60% MD and/or TD relax, at least 20% MD and/or TD relax, 50%, etc. MD and/or TD relax may, for example, reduce TD shrinkage of the product.

Transverse direction (TD) stretching may improve transverse direction tensile strength and may reduce splittiness of a microporous membrane compared to, for example, a microporous membrane that is not subjected to TD stretching and has only been subjected to machine direction (MD) stretching, e.g., the porous uniaxially-stretched membrane precursor described herein. Thickness may also be reduced, which is desirable. However, TD stretching may also result in decreased JIS Gurley, e.g., a JIS Gurley of less than 100 or less than 50, and increased porosity of the porous biaxially stretched membrane precursor as compared to the porous uniaxially (MD only) stretched membrane precursor, e.g., the MD-only stretched second non-porous precursor membrane described herein. TD shrinkage may also be increased by TD stretching of the MD stretched non-porous precursor, but this can be reduced somewhat by relax.

Calendering of the stretched non-porous precursor film is also not so limited and can be performed in any manner that is not contrary to the stated goals herein. For example, in some embodiments the calendering step may be performed as a means to reduce the thickness of the stretched (MD or MD and TD) first non-porous precursor film, as a means to reduce the porosity of the stretched (MD or MD and TD) first non-porous precursor film, and/or to further improve the transverse direction (TD) tensile strength or puncture strength of the stretched (MD or MD and TD) first non-porous precursor film. Calendering may also improve strength, wettability, and/or uniformity and reduce surface layer defects that have become incorporated during the manufacturing process e.g., during the MD and TD stretching processes. Using a texturized calendering roll may aid in adhesion, e.g., adhesion of the stretched (MD or MD and TD) or stretched (MD or MD and TD) and calendered first non-porous precursor film to the stretched second non-porous precursor film in the lamination step or may increase adhesion of a coating after the lamination step.

Calendering may be cold (below room temperature), ambient (room temperature), or hot (e.g., 90° C.) and may include the application of pressure or the application of heat and pressure to reduce the thickness in a controlled manner. In addition, the calendering process may use at least one of heat, pressure and speed to densify a heat sensitive material. In addition, the calendering process may use uniform or non-uniform heat, pressure, and/or speed to selectively densify a heat sensitive material, to provide a uniform or non-uniform calender condition (such as by use of a smooth roll, rough roll, patterned roll, micro-pattern roll, nano-pattern roll, speed change, temperature change, pressure change, humidity change, double roll step, multiple roll step, or combinations thereof), to produce improved, desired or unique structures, characteristics, and/or performance, to produce or control the resultant structures, characteristics, and/or performance, and/or the like.

In some preferred embodiments, calendering can reduce the thickness of the stretched (MD or MD and TD) first non-porous precursor. In some embodiments, thickness may be decreased by 30% or more, by 40% or more, by 50% or more, or by 60% or more. In some preferred embodiments, the thickness is reduced to 10 microns or less, sometimes 9, or 8, or 7, or 6, or 5, or 4, or 3, or 2 microns or less.

(2) Forming a Stretched or Stretched and Calendered First Non-Porous Precursor Film

The step of forming the stretched second non-porous precursor film is not so limited. The step may comprise, consist of, or consist essentially of extruding a second resin mixture to form a non-porous precursor film, and then, MD stretching the non-porous second precursor film to, among other things, form pores.

The extrusion step is not so limited. In preferred embodiments, the extrusion step is a dry extrusion step meaning the resin mixture is extruded without an oil or solvent. In other preferred embodiments, the extrusion step may involve co-extrusion where two or more resin mixtures are extruded to form a bi-layer, trilayer, or four or more layer non-porous precursor film. The two or more resin mixtures may each be the same or some or all of them may be different.

The resin mixture used in step (2) is not so limited and may comprise, consist of, or consist essentially of any extrudable resin, particularly a resin that is extrudable as part of a dry process such as the Celgard® dry process. In some preferred embodiments, the resin mixture used in step (2) comprises, consists of, or consists essentially of a polyethylene resin. The polyethylene resin is not so limited and in some embodiments may comprise a low or ultra-low molecular weight polyethylene resin. In some particularly preferred embodiments, the resin in step (1) comprises, consists of, or consists essentially of at least one of polypropylene or another high melt temperature resin and the resin in step (2) comprises, consists of, or consists essentially of at least one of a polyethylene resin and a resin having a melt temperature equal to or lower than 140 degrees centigrade, preferably equal to or lower than 135 degrees centigrade.

The MD stretching is not so limited. Machine direction (MD) stretch may be conducted as a single step or multiple steps, and as a cold stretch, as a hot stretch, or both (e.g., in multistep embodiments). In one embodiment, cold stretching may be carried out at <Tm−50° C., where Tm is the melting temperature of the polymer in the membrane precursor, and in another embodiment, at <Tm−80° C. In one embodiment, hot stretching may be carried out at <Tm−10° C. In one embodiment, total machine direction stretching may be in the range of 50-500% (i.e., .5 to 5×), and in another embodiment, in the range of 100-300% (i.e., 1 to 3×).This means the width (in the MD direction) of the membrane precursor increases by 50 to 500% or by 100 to 300% compared to the initial width, i.e., before any stretching, during MD stretching. In some preferred embodiments, the membrane precursor is stretched in the range of 180 to 250% (i.e., 1.8 to 2.5×). During machine direction stretch, the precursor may shrink in the transverse direction (conventional). In some preferred embodiments, MD and/or TD relaxation is performed during or after, preferably after, the MD stretch or during or after, preferably after, at least one step of the MD stretch process if it is multiple steps, including 10 to 90% MD and/or TD relax, 20 to 80% MD and/or TD relax, 30 to 70% MD and/or TD relax, 40 to 60% MD and/or TD relax, at least 20% MD and/or TD relax, 50%, etc. Not wishing to be bound by any particular theory, it is believed that performing MD stretching with TD relax keeps the pores that are formed by the MD stretching small. In other preferred embodiments, TD relaxation is not performed.

(3) Laminating Step

The lamination step is not so limited and can be performed in any manner that is not contrary to the stated goals herein. The lamination step comprises, consists of, or consists essentially of laminating the stretched (MD or MD and TD) or stretched (MD or MD and TD) and calendered first non-porous precursor film to the stretched second non-porous precursor film. In some embodiments, at least one other film is laminated with these two films in the lamination step. For example, a third MD stretched non-porous precursor film may be formed like in steps (1) or (2), a third MD and TD stretched non-porous precursor film may be formed like in step (1), or a third MD and TD stretched and calendered non-porous precursor film like that formed in step (2) may be formed and this third film may be laminated with the first and second film in any order. In some embodiments, the first film may comprise, consist, or consist essentially of polypropylene or another high melt temperature resin, the second film may comprise, consist of, or consist essentially of polyethylene, and the third film may comprise, consist, or consist essentially of polypropylene or another high melt temperature resin. In such an embodiment, the films may be laminated in the following order: first, second, third (PP-PE-PP). In some other embodiments, the first film may comprise, consist, or consist essentially of polypropylene or another high melt temperature resin, the second film may comprise, consist of, or consist essentially of polyethylene, and the third film may comprise, consist, or consist essentially of polyethylene and be only MD stretched. In such an embodiment, the films may be laminated in the following order: second, first, third (PE-PP-PE).

In some embodiments, laminating involves, for example, bringing a surface of the stretched (MD or MD and TD) or the stretched (MD or MD and TD) and calendered first non-porous precursor film into contact with a surface of the stretched second non-porous precursor film and fixing the two surfaces to one other using heat, pressure, and or heat and pressure. The third film may be laminated in the same way. Heat may be used, for example, to increase the tack of a surface of either or both of the co-extruded film and the at least one other film to make lamination easier, making the two surfaces stick or adhere together better. In some preferred embodiments, heat and pressure are used. In other preferred embodiments, e.g., examples where a treatment has been used, very little pressure and no heat are applied. Only enough pressure to bring the surfaces together may be needed.

(4) Calendering Step After Lamination

The calendering step after lamination is not so limited and can be performed in any manner that is not contrary to the stated goals herein. In some preferred embodiments, calendering is performed as part of step (1) and after the lamination step (3). In other preferred embodiments, calendering is only preformed after the lamination step (3) as part of the calendering step (4). The calendering conditions in step (4) are as described in step (2) above.

(5) Treatment Step

The treatment step is not so limited and can be performed in any manner that is not contrary to the stated goals herein. One purpose of the treatment step is to improve adhesion of the films laminated in the laminating step. The treatment step may be performed on at least one of these films (or all of these films) after they are formed. For example, it may be performed on the stretched (MD or MD and TD) first nonporous precursor film after stretching or on the stretched (MD or MD and TD) and calendered first nonporous precursor film after stretching and calendering.

Examples of treatment steps include corona treatment, plasma treatment, roughening, UV treatment, excimer irradiation, or use of an adhesive on one or more surfaces of the films.

In some embodiments where a treatment is applied, only slight pressure needs to be applied in the lamination step to laminate the films.

In other aspects, it may be calendered then coated (or treated), or coated then calendered, or calendered, coated, then calendered again.

Multilayer Microporous Membrane

The multilayer microporous membrane disclosed herein is not so limited and can be any membrane made by any of the methods described herein above. In other embodiments, the multilayer microporous membrane is one having at least one of the following properties:) a JIS Gurley between 50 and 400, between 100 and 400, between 150 and 400, between 100 and 300, or preferably between 100 and 200;b) a puncture strength between 150 gf and 600 gf, between 300 gf and 600 gf, between 320 gf and 600 gf, more preferably between 380 gf and 600 gf, and most preferably between 400 gf and 600 gf or more ;c) an MD strength above 500 kg/cm², above 600 kg/cm², above 700 kg/cm² and preferably above 1,000 kg/cm²; d) A TD strength above 300 kg/cm², above 350 kg/cm², preferably above 500 kg/cm², and most preferably above 600 kg/cm²; e) an MD elongation preferably equal to or above 30%, equal to or above 40%, equal to above 50%, or more preferably above 100%; f) a TD elongation preferably equal to or above 30%, or 40%, or 50%, or 60% or more preferably equal to or above 70%; g) an MD shrinkage at least one of 105° C., 120° C., 130° C., or 140° C. that is below 25%, more preferably below 20%, even more preferably below 15%; and most preferably 10% or less; h) a TD shrinkage at least one of 105° C., 120° C., 130° C., or 140° C. that is below 15%, preferably below 10%, and most preferably below 5%; i) reduced splittiness; j) good uniformity, and as a result, a higher minimum dielectric breakdown value; k) a thickness of 25 microns or less, preferably 20 microns or less, most preferably 15 microns or less; and l) reduced moisture. The membrane may have two or more, three or more, four or more, five or more, six or more, seven or more, eight or more, nine or more, ten or more, eleven or more, or all twelve of the foregoing properties.

In some embodiments, there is improved MD/TD balance, e.g., a ratio of the MD and TD properties is from 0.8:1.2 to 1.2:0.8.

In other embodiments, the multilayer microporous membrane is one having properties that are better than or competitive with a coated and/or uncoated wet process membrane. For example, it may have at least one of better puncture strength, MD shrinkage, or TD shrinkage.

Multilayer means that the membrane has two or more layers or four or more layers in embodiments where the first and second nonporous precursor films are formed by coextrusion. Each of the layers may have thicknesses ranging from 0.1 to 50 microns. Co-extruded layers may be thinner than mono-extruded layers.

Microporous as used herein means that the average pore size of the film, membrane, or coating is 1 micron or less, 0.9 microns or less, 0.8 microns or less, 0.7 microns or less, 0.6 microns or less, 0.5 microns or less, 0.4 microns or less, 0.3 microns or less, 0.2 microns or less, and preferably 0.1 microns or less, 0.09 microns or less, 0.08 microns or less, 0.07 microns or less, 0.06 microns or less, 0.05 microns or less, 0.04 microns or less, 0.03 microns or less, 0.02 microns or less, or 0.01 microns or less. In preferred embodiments, pores may be formed, for example, by performing a stretching process on a precursor film, e.g., as is done in the Celgard® dry process.

Battery Separator

In another aspect, a battery separator comprising, consisting of, or consisting essentially of at least one multilayer microporous membrane as disclosed herein is described. In some particularly preferred embodiments, the microporous membrane does not need a coating, particularly a ceramic coating, because the properties of the membranes do not require it for, for example, improving shrinkage. Not coating the separator lowers the overall cost of the separator. In some embodiments herein a superior separator may be formed at lower costs and reduces moisture. However, in some embodiments, a coating, e.g., a ceramic coating, may be added to even further improve the properties of the separator.

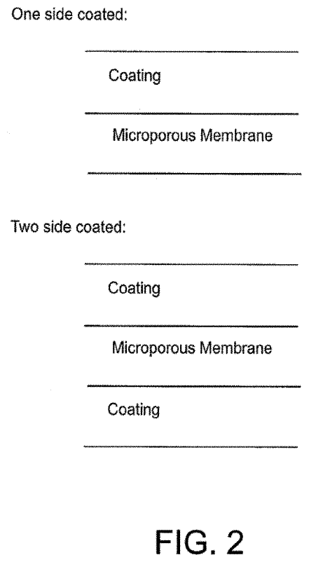

In some embodiments, the at least one microporous membrane may be coated on one or two sides to form a one or two-side coated battery separator. One-sided coated separators and two-side coated battery separators according to some embodiments herein are shown in FIG. 2.

The coating layer may comprise, consist of, or consist essentially of, and/or be formed from, any coating composition. For example, any coating composition described in U.S. Pat. No. 6,432,586 may be used. The coating layer may be wet, dry, cross-linked, uncross-linked, etc.

In one aspect, the coating layer may be an outermost coating layer of the separator, e.g., it may have no other different coating layers formed thereon, or the coating layer may have at least one other different coating layer formed thereon. For example, in some embodiments, a different polymeric coating layer may be coated over or on top of the coating layer formed on at least one surface of the porous substrate. In some embodiments, that different polymeric coating layer may comprise, consist of, or consist essentially of at least one of polyvinylidene difluoride (PVdF) or polycarbonate (PC).

In some embodiments, the coating layer is applied over top of one or more other coating layers that have already been applied to at least one side of the microporous membrane. For example, in some embodiments, these layers that have already been applied to a the microporous membrane are thin, very thin, or ultra-thin layers of at least one of an inorganic material, an organic material, a conductive material, a semi-conductive material, a non-conductive material, a reactive material, or mixtures thereof. In some embodiments, these layer(s) are metal or metal oxide-containing layers. In some preferred embodiments, a metal-containing layer and a metal-oxide containing layer, e.g., a metal oxide of the metal used in the metal-containing layer, are formed on the porous substrate before a coating layer comprising a coating composition described herein is formed. Sometimes, the total thickness of these already applied layer or layers is less than 5 microns, sometimes, less than 4 microns, sometimes less than 3 microns, sometimes less than 2 microns, sometimes less than 1 micron, sometimes less than 0.5 microns, sometimes less than 0.1 microns, and sometimes less than 0.05 microns.

In some embodiments, the thickness of the coating layer formed from the coating compositions described hereinabove, e.g., the coating compositions described in U.S. Pat. No. 8,432,586, is less than about 12 μm, sometimes less than 10 μm, sometimes less than 9 μm, sometimes less than 8 μm, sometimes less than 7 μm, and sometimes less than 5 μm. In at least certain selected embodiments, the coating layer is less than 4 μm, less than 2 μm, or less than 1 μm.

The coating method is not so limited, and the coating layer described herein may be coated onto a porous substrate, e.g., as described herein, by at least one of the following coating methods: extrusion coating, roll coating, gravure coating, printing, knife coating, air-knife coating, spray coating, dip coating, or curtain coating. The coating process may be conducted at room temperature or at elevated temperatures.

The coating layer may be any one of nonporous, nanoporous, microporous, mesoporous or macroporous. The coating layer may have a JIS Gurley of 700 or less, sometimes 600 or less, 500 or less, 400 or less, 300 or less, 200 or less, or 100 or less. For a nonporous coating layer, the JIS Gurley can be 800 or more, 1,000 or more, 5,000 or more, or 10,000 or more (i.e., “infinite Gurley”) For a nonporous coating layer, although the coating is nonporous when dry, it is a good ionic conductor, particularly when it becomes wet with electrolyte.

Composite or Device

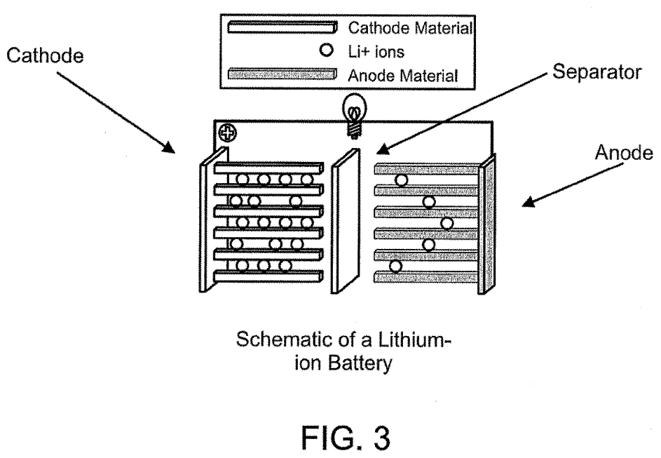

A composite or device comprising any battery separator as described hereinabove and one or more electrodes, e.g., an anode, a cathode, or an anode and a cathode, provided in direct contact therewith. The type of electrodes are not so limited. For example the electrodes can be those suitable for use in a lithium ion secondary battery.
A lithium-ion battery according to some embodiments herein is shown in FIG. 3.

A suitable anode may have an energy capacity greater than or equal to 372 mAh/g, preferably ≥700 mAh/g, and most preferably ≥1000 mAH/g. The anode be constructed from a lithium metal foil or a lithium alloy foil (e.g. lithium aluminum alloys), or a mixture of a lithium metal and/or lithium alloy and materials such as carbon (e.g. coke, graphite), nickel, copper. The anode is not made solely from intercalation compounds containing lithium or insertion compounds containing lithium.

A suitable cathode may be any cathode compatible with the anode and may include an intercalation compound, an insertion compound, or an electrochemically active polymer. Suitable intercalation materials includes, for example, MoS₂, FeS₂, MnO₂, TiS₂, NbSe₃, LiCoO₂, LiNiO₂, LiMn₂O₄, V₆O₁₃, V₂O₅, and CuCl₂. Suitable polymers include, for example, polyacetylene, polypyrrole, polyaniline, and polythiopene.

Any battery separator described hereinabove may be incorporated to any vehicle, e.g., an e-vehicle, or device, e.g., a cell phone or laptop, that is completely or partially battery powered.

Various embodiments of the invention have been described in fulfillment of the various objects of the invention. It should be recognized that these embodiments are merely illustrative of the principles of the present invention. For example, the membranes of the present invention may find many uses besides or beyond battery separators, such as, in disposable lighters, textiles, displays, capacitors, medical items, filtration, humidity control, fuel cells, etc. Numerous modifications and adaptations will be readily apparent to those skilled in the art without departing from the spirit and scope of this invention.

### EXAMPLES

Example 1—By using PP resin which has a melting point at 161 degrees centigrade, two non-porous PP layers were extruded, and each was MD stretched and then TD stretched to obtain 10.5 μm film. Also, by using PE resin which has a melting point at 135 degrees centigrade, non-porous PE layer was extruded, and then the non-porous PE layer was MD stretched to obtain 3.5 μm film. Then, the two stretched PP layers and the stretched PE layer were laminated together to form a tri-layer structure PP-PE-PP to obtain 24 μm film.
Example 2—Using same PP and PE resins with example 1, two non-porous PP layers were extruded, and each was MD stretched and then TD stretched to obtain 15 μm film. After that, the MD & TD stretched films were calendered to obtain 9 μm film. Also, a non-porous PE layer was extruded, and then the non-porous PE layer was MD stretched to obtain Tum film. Then, the two stretched PP layers and the stretched PE layer were laminated together to form a tri-layer structure PP-PE-PP to obtain 25 μm film.
Example3—Using same PP and PE resins with example 1, two non-porous PP layers were extruded, and each was MD stretched and then TD stretched to obtain 9 μm film. After that, the MD & TD stretched films were calendered to obtain 5.5 μm film. Also, a non-porous PE layer was extruded, and then the non-porous PE layer was MD stretched to obtain 4 μm film. Then, the two stretched PP layers and the stretched PE layer were laminated together to form a tri-layer structure PP-PE-PP to obtain 15 μm film.
Example4—Using same PP and PE resins with example 1, two non-porous PP layers were extruded, and each was MD stretched and then TD stretched to obtain 6.5 μm film. After that, the MD & TD stretched films were calendered to obtain 4 μm film. Also, a non-porous PE layer was extruded, and then the non-porous PE layer was MD stretched to obtain Tum film. Then, the two stretched PP layers and the stretched PE layer were laminated together to form a tri-layer structure PP-PE-PP to obtain 15 μm film.
Example5—Using same PP and PE resins with example 1, two non-porous PP layers were extruded, and each was MD stretched and then TD stretched to obtain 6.5 μm film. After that, the MD & TD stretched films were calendered to obtain 3.5 μm film. Also, a non-porous PE layer was extruded, and then the non-porous PE layer was MD stretched to obtain 3 μm film. Then, the two stretched PP layers and the stretched PE layer were laminated together to form a tri-layer structure PP-PE-PP to obtain 10 μm film.
Example6—By using resin which has a melting point at 164 degrees centigrade, two non-porous PP layers were extruded, and each was MD stretched and then TD stretched to obtain 9 μm film. After that, the MD & TD stretched films were calendered to obtain 5.5 μm film. Also, by using PE resin which has a melting point at 135 degrees centigrade, a non-porous PE layer was extruded, and then the non-porous PE layer was MD stretched to obtain 4 μm film. Then, the two stretched PP layers and the stretched PE layer were laminated together to form a tri-layer structure PP-PE-PP to obtain 15 μm film.
Example 7—Using same PP and PE resins with example 1, two non-porous PP layers were extruded, and each was MD stretched and then TD stretched to obtain 10.5 μm film. Also, a non-porous PE layer was extruded, and then the non-porous PE layer was MD stretched to obtain 3.5 μm film. Then, the two stretched PP layers and the stretched PE layer were laminated together to form a tri-layer structure PP-PE-PP. The following process is identical to the process for Example 1. However, in Example 7, the tri-layer structure PP-PE-PP is then calendered to obtain 16 μm film.
Example8—Using same PP and PE resins with example 1, two non-porous PP layers were extruded, and each was MD stretched and then TD stretched to obtain 12 μm film. After that, the MD & TD stretched films were calendered to obtain Tum film. Also, a non-porous PE layer was extruded, and then the non-porous PE layer was MD stretched to obtain 5.5 μm film. Then, the two stretched PP layers and the stretched PE layer were laminated together to form a tri-layer structure PP-PE-PP to obtain 20 μm film. After the lamination, the film was calendered again to obtain 15 μm film.
Example 9—Using same PP and PE resins with example 1, two non-porous PE layers were extruded, and each was MD stretched to obtain 3.5 μm film. Also, a non-porous PP layer was extruded, and then the non-porous PP layer was MD and TD stretched to obtain 10.5 μm film in that order. Then, the two stretched PE layers and the stretched PP layer were laminated together to form an inverted tri-layer structure PE-PP-PE to obtain 1 6 μm film.
Example 10—Using same PP and PE resins with example 1, two non-porous PE layers were extruded, and each was MD stretched to obtain 3.5 μm film. Also, a non-porous PP layer was extruded, and then the non-porous PP layer was MD and TD stretched to obtain 13 μm film in that order. After that, the MD & TD stretched film was calendered to obtain Bum film. Then, the two stretched PE layers and the stretched PP layer were laminated together to form an inverted tri-layer structure PE-PP-PE to obtain 15 μm film.
Example 11—Using same PP and PE resins with example 1, two non-porous PE layers were extruded, and each was MD stretched to obtain 3.5 μm film. Also, a non-porous PP layer was extruded, and then the non-porous PP layer was MD and TD stretched to obtain 10.5 μm film in that order. Then, the two stretched PE layers and the stretched PP layer were laminated together to form an inverted tri-layer structure PE-PP-PE to obtain 1 6 μm film. The following process is identical to the process for Example 9. However, in Example 11, the inverted tri-layer structure PE-PP-PE is then calendered to obtain 11 μm film.
Example 12—Using same PP and PE resins with example1, one non-porous PP layer was extruded, and it was MD stretched and then TD stretched to obtain 18 μm film. After that, the MD & TD stretched film was calendered to obtain 11 μm film. Also, a non-porous PE layer was extruded, and then the non-porous PE layer was MD stretched to obtain 4 μm film. Then, the stretched PP layer and the stretched PE layer were laminated together to form a bi-layer structure PP-PE to obtain 15 μm film.
Example 13—Using same PP and PE resins with example1, one Non-porous PE layer was extruded, and each was MD stretched to obtain 4 μm film. Also, a non-porous PP layer was extruded, and then the non-porous PP layer was MD and TD stretched to obtain 18 μm film in that order. Then, the two stretched PE layers and the stretched PP layer were laminated together to form bi-layer structure PE-PP to obtain 22 μm film. The bi-layer structure PE-PP is then calendered to obtain 15 μm film.
Comparative Example 1—Two non-porous PP layers and one non-porous PE layer were extruded and laminated together to form a tri-layer structure, PP-PE-PP. The laminate was then MD stretched only to obtain 14 μm film.
Comparative Example 2—Two non-porous PP layers and one non-porous PE layer were extruded and laminated together to form a tri-layer structure, PP-PE-PP. The laminate was then MD stretched, then TD stretched, and then calendered to obtain 15 μm film.
Comparative Example 3—A PP non-porous layer was extruded, and then MD stretched and TD stretched to obtain 10.5 μm film. Comparative Example 3 may be a precursor material for Examples 1, 7, 9, and 11.
Comparative Example 4 (3.5 μm PE)—A PE non-porous layer was extruded and then MD stretched. Comparative Example 4 may be a precursor material for Examples 1, 7, 9, 10, and 11.

The thickness, JIS Gurley, Porosity, basis weight, puncture strength, MD strength, TD strength, MD elongation, TD elongation, MD shrinkage, and TD shrinkage of Examples 1-3 and Comparative Examples 1-4 were measured and are reported in Table 1 below:

TABLE 1

| | | | | | | | | | | | | | | Comp. | Comp. | Comp. | Comp. |
|---|---|---|---|---|---|---|---|---|---|---|---|---|---|---|---|---|---|
| | Ex 1 | Ex 2 | Ex 3 | Ex 4 | Ex 5 | Ex 6 | Ex 7 | Ex 8 | Ex 9 | Ex 10 | Ex 11 | Ex 12 | Ex 13 | Ex 1 | Ex 2 | Ex 3 | Ex 4 |
| Thickness | 24 | 25 | 15 | 15 | 10 | 15 | 16 | 15 | 16 | 15 | 11 | 15 | 15 | 14 | 15 | 11 | 3.5 |
| JIS Gurley | 150 | 270 | 150 | 150 | 100 | 150 | 360 | 300 | 140 | 150 | 220 | 150 | 200 | 200 | 180 | 35 | 30 |
| Porosity | 65 | 50 | 50 | 50 | 50 | 50 | 49 | 40 | 58 | 50 | 40 | 50 | 50 | 45 | 52 | 64 | 55 |
| (%) | | | | | | | | | | | | | | | | | |
| Basis | 8.0 | 12.3 | 6.9 | 6.9 | 4.6 | 6.9 | 8.0 | 8.4 | 6.2 | 6.9 | 6.2 | 6.9 | 6.9 | 7.6 | 6.7 | 3.5 | 1.4 |
| Weight | | | | | | | | | | | | | | | | | |
| (g/m²) | | | | | | | | | | | | | | | | | |
| Puncture | 390 | 630 | 350 | 320 | 230 | 440 | 420 | 430 | 320 | 380 | 320 | 440 | 440 | 300 | 370 | 180 | 80 |
| strength | | | | | | | | | | | | | | | | | |
| (gf) | | | | | | | | | | | | | | | | | |
| MD | 760 | 1200 | 1100 | 1650 | 1100 | 1200 | 1110 | 1550 | 1340 | 1600 | 1800 | 1400 | 1400 | 2100 | 1400 | 1050 | 1400 |
| Strength | | | | | | | | | | | | | | | | | |
| (kg/cm²) | | | | | | | | | | | | | | | | | |
| TD | 520 | 550 | 650 | 420 | 650 | 650 | 630 | 800 | 360 | 450 | 500 | 500 | 500 | 140 | 560 | 550 | 50 |
| strength | | | | | | | | | | | | | | | | | |
| (kg/cm²) | | | | | | | | | | | | | | | | | |
| MD | 110 | 40 | 50 | 35 | 50 | 50 | 50 | 45 | 11 | 40 | 45 | 45 | 45 | 40 | 100 | 140 | 8 |
| Elongation | | | | | | | | | | | | | | | | | |
| (%) | | | | | | | | | | | | | | | | | |
| TD | 60 | 80 | 70 | 100 | 70 | 70 | 70 | 75 | 60 | 120 | 80 | 80 | 80 | 740 | 150 | 120 | 90 |
| Elongation | | | | | | | | | | | | | | | | | |
| (%) | | | | | | | | | | | | | | | | | |
| MD | 8 | 3 | 3 | 6 | 3 | 3 | 10 | 3 | 10 | 5 | 3 | 3 | 3 | 1 | 9 | 1 | 20 |
| shrinkage | | | | | | | | | | | | | | | | | |
| (% @ | | | | | | | | | | | | | | | | | |
| 105° C.) | | | | | | | | | | | | | | | | | |
| MD | 16 | 5 | 5 | 8 | 5 | 5 | 15 | 5 | 22 | 7 | 5 | 5 | 5 | 7 | 17 | 6 | 40 |
| shrinkage | | | | | | | | | | | | | | | | | |
| (% @ | | | | | | | | | | | | | | | | | |
| 120° C.) | | | | | | | | | | | | | | | | | |
| MD | 26 | 7 | 8 | 10 | 7 | 10 | 23 | 7 | 32 | 9 | 7 | 7 | 7 | 19 | 36 | 12 | 50 |
| shrinkage | | | | | | | | | | | | | | | | | |
| (% @ | | | | | | | | | | | | | | | | | |
| 130° C.) | | | | | | | | | | | | | | | | | |
| MD | 35 | 12 | 10 | 20 | 15 | 18 | 34 | 15 | 45 | 20 | 15 | 15 | 15 | 30 | 39 | 50 | 65 |
| shrinkage | | | | | | | | | | | | | | | | | |
| (% @ | | | | | | | | | | | | | | | | | |
| 140° C.) | | | | | | | | | | | | | | | | | |
| TD | 0 | 0 | 0 | 0 | 0 | 0 | 2 | 1 | 0 | 0 | 0 | 1 | 1 | 0 | 4 | 0 | 0 |
| shrinkage | | | | | | | | | | | | | | | | | |
| (% @ | | | | | | | | | | | | | | | | | |
| 105° C.) | | | | | | | | | | | | | | | | | |
| TD | 1 | 1 | 1 | 1 | 1 | 1 | 3 | 2 | 2 | 2 | 2 | 2 | 2 | 0 | 9 | 0 | 0 |
| shrinkage | | | | | | | | | | | | | | | | | |
| (% @ | | | | | | | | | | | | | | | | | |
| 120° C.) | | | | | | | | | | | | | | | | | |
| TD | 2 | 2 | 2 | 2 | 2 | 4 | 6 | 3 | 5 | 5 | 5 | 3 | 3 | 0 | 15 | 1 | 0 |
| shrinkage | | | | | | | | | | | | | | | | | |
| (% @ | | | | | | | | | | | | | | | | | |
| 130° C.) | | | | | | | | | | | | | | | | | |
| TD | 6 | 5 | 5 | 5 | 5 | 7 | 10 | 7 | 8 | 8 | 8 | 7 | 7 | 0 | 26 | 10 | 0 |
| shrinkage | | | | | | | | | | | | | | | | | |
| (% @ | | | | | | | | | | | | | | | | | |
| 140° C.) | | | | | | | | | | | | | | | | | |
| Shutdown | 129 | 129 | 129 | 130 | 130 | 130 | 128 | 130 | 129 | 127 | 127 | 129 | 129 | 129 | 132 | 160 | 130 |
| Temper- | | | | | | | | | | | | | | | | | |
| ature | | | | | | | | | | | | | | | | | |
| (° C.) | | | | | | | | | | | | | | | | | |

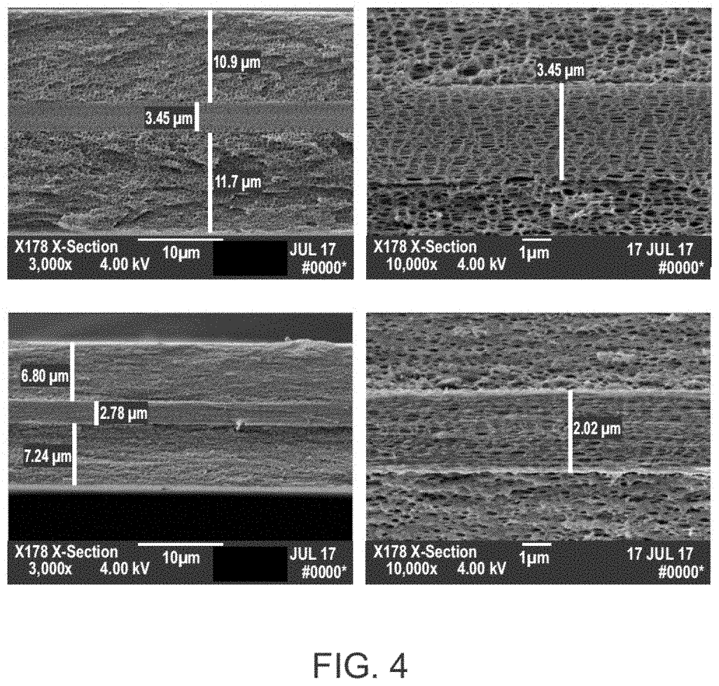

SEM cross-sections of Example 1 (top two in FIG. 4) and Example 7 (bottom two in FIG. 4) are shown in FIG. 4.

It is believed that the methods disclosed herein could produce a membrane that is competitive with wet product, including a ceramic coated wet product. The membrane could have properties that are competitive with a coated or uncoated wet process product even without the application of a ceramic coating. Notably, wet process products must be coated to prevent oxidation due to exposed polyethylene in wet process membranes. Thus, the membranes disclosed herein would be competitive with wet process membranes from a cost perspective as well. They have properties competitive with a coated wet process product, without requiring the extra cost for coating.

Table 2 below shows a comparison between a product made according to the new and improved methods disclosed herein, Example 3 and 7; comparative dry products made by prior method, Comparative Examples 1, 2 and 3, and coated and uncoated wet process membranes.

TABLE 2

| | | | | | | | Ceramic Coated |
|---|---|---|---|---|---|---|---|
| | | | | | | Uncoated | Wet process |
| | | | | | | Wet | Example with a |
| | Comparative | Comparative | Comparative | | | process | 2 μm coating |
| | Example 1 | Example 2 | Example 3 | Exapmle3 | Example 7 | Example | on one side |
| Thickness | 14 | 15 | 11 | 15 | 16 | 16 | 15 |
| (μm) | | | | | | | |
| JIS Gurley | 200 | 180 | 35 | 150 | 360 | 210 | 150 |
| Porosity % | 45 | 52 | 64 | 50 | 49 | 45 | 43 |
| Puncture | 300 | 370 | 180 | 350 | 420 | 480 | 340 |
| Strength | | | | | | | |
| (gf) | | | | | | | |
| MD/TD | 2100/140 | 1400/560 | 1050/550 | 1150/650 | 1110/630 | 1300/1200 | 1000/1000 |
| strength | | | | | | | |
| (kg/cm²) | | | | | | | |
| MD/TD | 40/740 | 100/150 | 140/120 | 50/70 | 50/70 | 60/80 | 70/70 |
| elongation | | | | | | | |
| (%) | | | | | | | |
| MD | 1/7/19/30 | 9/17/36/39 | 1/6/12/50 | 3/5/8/10 | 10/15/23/34 | 5/11/27/40 | 0/1/4/18 |
| Shrinkage | | | | | | | |
| (%), (105, | | | | | | | |
| 120, 130, | | | | | | | |
| 140 C) | | | | | | | |
| TD | 0/0/0/0 | 4/9/15/26 | 0/0/1/10 | 0/1/2/5 | 2/3/6/10 | 0/3/19/30 | 0/1/2/18 |
| Shrinkage | | | | | | | |
| (%) (105, | | | | | | | |
| 120, 130, | | | | | | | |
| 140 C) | | | | | | | |
| Oxidation | — | — | — | — | — | Blackening | — |
| Shut down | 129 | 132 | 160 | 129 | 128 | 140 | 140 |
| Cost | Low | Low | Low | Medium | Medium | Medium | High |

The following 15 publications are hereby incorporated by reference herein. The improved membranes and separators of this application may serve as precursors, layers, membranes, substrates, base films, and/or separators for the products or separators disclosed therein: US2017/362745, US2017/266865, US2017/222281, US2017/222205, U52017/033346, 2017/214023, US2017/084898, 2017/062785, US2017/025658, US2016/359157, US2016/329541, US2016/248066, US2016/204409, US2016/164060, and US2016/149182.

Disclosed herein is an improved membrane, separator and/or method for forming a multilayer microporous membrane for use in an improved battery separator, particularly a battery separator for a lithium ion secondary battery. Also disclosed herein is the multilayer microporous membrane formed by this method, which has properties that compete with or exceed those of wet process, coated or uncoated, membranes that are also useable in battery separators. Also disclosed are battery separators comprising the multilayer microporous membrane and batteries, vehicles, or devices comprising the separators. The method may comprise at least the following steps: (1) forming a stretched first non-porous precursor film that has pores due to the stretching of a first non-porous precursor film; (2) separately forming a second stretched non-porous precursor film that has pores due to the stretching of a second non-porous precursor film; and then (3) laminating the stretched first non-porous precursor and the stretched second non-porous precursor.

In accordance with at least selected embodiments, aspects or objects, this application, disclosure or invention is directed to and/or provides new and/or improved microporous membranes, battery separators including said microporous membranes, and/or methods for making and/or using new and/or improved microporous membranes and battery separators comprising said microporous membranes. For example, the new and/or improved microporous membranes, and battery separators comprising the same, have a better balance of desirable properties than prior microporous membranes. Also, the new and/or improved methods produce microporous membranes, and battery separators comprising the same, having a better balance of desirable properties than prior microporous membranes. The new and/or improved microporous membranes and battery separators including said microporous membranes are competitive with or better than coated or un-coated wet-process microporous membranes and battery separators including coated or un-coated wet-process microporous membranes, respectively.

Disclosed, shown or claimed herein is an improved membrane, separator and/or method for forming a multilayer microporous membrane for use in an improved battery separator, particularly a battery separator for a lithium ion secondary battery. Also disclosed herein the multilayer microporous membrane formed by this method, preferably has properties that compete with or exceed those of wet process, coated or uncoated, membranes that are also useable in battery separators. Also disclosed are battery separators comprising the multilayer microporous membrane and batteries, vehicles, or devices comprising the separators. The dry process method may comprise at least the following steps: (1) forming a stretched first non-porous precursor film that has pores due to the stretching of a first non-porous precursor film; (2) separately forming a second stretched non-porous precursor film that has pores due to the stretching of a second non-porous precursor film; and then (3) laminating the stretched first non-porous precursor and the stretched second non-porous precursor.

### TEST METHODS

Thickness(μm)

Thickness is measured in micrometers, pm, using the Emveco Microgage 210-A micrometer thickness tester and test procedure ASTM D374.

JIS Gurley (s/100 cc)

Gurley is defined herein as the Japanese Industrial Standard (JIS Gurley) and is measured herein using the OHKEN permeability tester. JIS Gurley is defined as the time in seconds required for 100 cc of air to pass through one square inch of film at a constant pressure of 4.9 inches of water.

% MD or TD Shrinkage at 105, 120, 130, and 140° C.

Shrinkage is measured by placing a test sample between two sheets of paper which is then clipped together to hold the sample between the papers and suspended in an oven. For the ‘105° C. for 1 hour’ testing, a sample is placed in an oven at 105° C. for 1 hour. After the designated heating time in the oven, each sample was removed and taped to a flat counter surface using double side sticky tape to flatten and smooth out the sample for accurate length and width measurement. Shrinkage is measured in the both the Machine direction (MD) and Transverse direction (TD) direction and is expressed as a % MD shrinkage and % TD shrinkage.

MD Tensile Strength (kgf/cm²)

Machine Direction (MD) tensile strength is measured using Instron Model 4201 according to ASTM-882 procedure.

MD Elongation (%)

% MD elongation at break is the percentage of extension of a test sample along the machine direction of the test sample measured at the maximum tensile strength needed to break a sample.

TD Tensile Strength (kgf/cm²)

Transverse Direction (TD) tensile strength is measured using Instron Model 4201 according to ASTM-882 procedure.

TD Elongation (%)

% TD elongation at break is the percentage of extension of a test sample along the transverse direction of the test sample measured at the maximum tensile strength needed to break a sample.

Puncture Strength (gf)

Puncture Strength is measured using Instron Model 4442 based on ASTM D3763. The measurements are made across the width of the microporous membrane and the puncture strength defined as the force required to puncture the test sample.

DB Minimum (V)

Voltage is applied to a separator membrane until the dielectric breakdown of the sample is observed. Strong separators show high DB.

Shutdown Temp (° C.)

A sample is heated and the onset temperature for shutdown is recorded at the resistance reading of 100 W×cm² and is reported in ° C.

Moisture

Moisture is measured by the Karl Fischer titration method.

This application is not limited to the above embodiments.

1. A method for forming a multilayer microporous membrane, comprising:
extruding a first resin mixture to form a first nonporous precursor film and then stretching the first nonporous precursor film in at least the machine direction (MD) to form pores;
separately extruding a second resin mixture to form a second nonporous precursor film and then stretching the second nonporous precursor film in the machine direction (MD) to form pores; and
laminating the MD stretched first precursor and the MD stretched second precursor, wherein optionally:
the first resin mixture comprises at least one of a polypropylene resin and a resin having a melt temperature equal to or greater than 140 degrees centigrade and equal to or less than 330 degrees centigrade, or
the first resin mixture comprises at least one of a polypropylene resin and a resin having a melt temperature equal to or greater than 140 degrees centigrade and equal to or less than 330 degrees centigrade, and the second resin mixture comprises at least one of a polyethylene resin and a resin having a melt temperature equal to or lower than 140 degrees centigrade, preferably equal to or lower than 135 degrees centigrade.

2. (canceled)

3. (canceled)

4. The method of claim 1, wherein at least one of first nonporous precursor film and the second nonporous precursor film is a co-extruded film formed by co-extruding at least one other resin mixture along with the first or second resin mixture, wherein the other resin mixture may be the same or different than the first or second resin mixture.

5. The method of claim 1, wherein the first nonporous precursor is sequentially or simultaneously stretched in the MD and in the transverse direction (TD) prior to laminating.

6. (canceled)

7. The method of claim 1, wherein the MD stretched first nonporous precursor is calendered prior to laminating; or
wherein the first nonporous precursor is sequentially or simultaneously stretched in the MD and in the transverse direction (TD) prior to laminating, and the MD and TD stretched first nonporous precursor is calendered prior to laminating.

8. (canceled)

9. (canceled)

10. (canceled)

11. The method of claim 1, wherein after laminating the MD stretched first nonporous precursor and the MD stretched second nonporous precursor, the laminate is calendered; or
wherein the first nonporous precursor is sequentially or simultaneously stretched in the MD and in the transverse direction (TD) prior to laminating, the MD and TD stretched first nonporous precursor is calendered prior to laminating, and after laminating the MD and TD stretched first nonporous precursor and the MD stretched second nonporous precursor, the laminate is calendered.

12. (canceled)

13. (canceled)

14. (canceled)

15. The method of claim 1, wherein at least one of the MD stretched first nonporous precursor and the MD stretched second nonporous precursor are treated prior to laminating to improve adhesion; or
wherein the first nonporous precursor is sequentially or simultaneously stretched in the MD and in the transverse direction (TD) prior to laminating, and wherein at least one of the MD stretched first nonporous precursor and the MD stretched second nonporous precursor are treated prior to laminating to improve adhesion.

16. (canceled)

17. (canceled)

18. (canceled)

19. (canceled)

20. (canceled)

21. (canceled)

22. The method of claim 11, wherein at least one of the MD stretched first nonporous precursor and the MD stretched second nonporous precursor are treated after stretching, but prior to laminating, to improve adhesion.

23. (canceled)

24. (canceled)

25. (canceled)

26. The method of claim 15, wherein the treatment for the precursors is at least one selected from the group consisting of pre-heating, corona treatment, plasma treatment, roughening, UV irradiation, excimer irradiation, or application of an adhesive.

27. The method of claim 1, wherein the multilayer microporous membrane comprises:
the first MD stretched nonporous precursor film, which comprises at least one of a polypropylene resin and a resin having a melt temperature equal to or greater than 140 degrees centigrade and equal to or less than 330 degrees centigrade;
the second MD stretch nonporous precursor film, which comprises a polyethylene resin; and
a third film comprising at least one of a polypropylene resin and a resin having a melt temperature equal to or greater than 140 degrees centigrade and equal to or less than 330 degrees centigrade, wherein the films are laminated together in that order, i.e., first precursor-second precursor-third film, wherein
the third film is optionally formed by extruding a resin mixture comprising at least one of a polypropylene resin and a resin having a melt temperature equal to or greater than 140 degrees centigrade and equal to or less than 330 degrees centigrade to form a third nonporous precursor and then stretching the third nonporous precursor in the machine direction (MD) to form pores.

28. (canceled)

29. The method of claim 1, wherein the multilayer microporous membrane comprises:
the first MD stretched nonporous precursor film, which comprises at least one of a polypropylene resin and a resin having a melt temperature equal to or greater than 140 degrees centigrade and equal to or less than 330 degrees centigrade;
the second MD stretch nonporous precursor film, which comprises a polyethylene resin; and
a third film comprising polyethylene wherein the films are laminated together in the following order: second precursor, first precursor, third film, wherein
the third film is formed by extruding a resin mixture comprising a polyethylene resin to form a third nonporous precursor and then stretching the third nonporous precursor in the machine direction (MD) to form pores.

30. (canceled)

31. The method of claim 1, wherein the multilayer microporous membrane is a bilayer microporous membrane, a trilayer microporous membrane, a microporous membrane having four or more layers, a dry process bilayer microporous membrane, a dry process trilayer microporous membrane, or a dry process microporous membrane having four or more layers.

32. (canceled)

33. (canceled)

34. The method of claim 1, wherein the second resin mixture comprises at least one of a polyethylene resin and a resin having a melt temperature equal to or lower than 140 degrees centigrade, preferably equal to or lower than 135 degrees centigrade, and the first nonporous precursor is sequentially or simultaneously stretched in the MD and in the TD prior to laminating.

35. The method of claim 34, wherein
at least one of the MD and TD stretched first nonporous precursor and the MD stretched second nonporous precursor are treated after stretching, but prior to laminating, to improve adhesion;
the MD and TD stretched first nonporous precursor is calendered prior to laminating;
the MD and TD stretched first nonporous precursor is calendered prior to laminating, and at least one of the MD stretched first nonporous precursor and the MD stretched second nonporous precursor are treated after stretching, but prior to laminating, to improve adhesion;
after laminating the MD and TD stretched first nonporous precursor and the MD stretched second nonporous precursor, the laminate is calendered; or
wherein after laminating the MD and TD stretched first nonporous precursor and the MD stretched second nonporous precursor, the laminate is calendered, and at least one of the MD and TD stretched first nonporous precursor and the MD stretched second nonporous precursor are treated after stretching, but prior to laminating, to improve adhesion.

36. (canceled)

37. (canceled)

38. (canceled)

39. (canceled)

40. The method of claim 1, wherein:
the second resin mixture comprises at least one of a polyethylene resin and a resin having a melt temperature equal to or lower than 140 degrees centigrade, preferably equal to or lower than 135 degrees centigrade, and the MD stretched first nonporous precursor is calendered prior to laminating;
the second resin mixture comprises at least one of a polyethylene resin and a resin having a melt temperature equal to or lower than 140 degrees centigrade, preferably equal to or lower than 135 degrees centigrade, and at least one of the MD stretched first nonporous precursor and the MD stretched second nonporous precursor are calendered prior to lamination; or
the second resin mixture comprises at least one of a polyethylene resin and a resin having a melt temperature equal to or lower than 140 degrees centigrade, preferably equal to or lower than 135 degrees centigrade, and both of the MD stretched first nonporous precursor and the MD stretched second nonporous precursor are calendered prior to lamination.

41. (canceled)

42. (canceled)

43. The method of claim 40, wherein at least one of the MD stretched nonporous precursor and the MD stretched second nonporous precursor are treated after stretching, before or after calendering, and prior to lamination to improve adhesion.

44. A multilayer microporous membrane formed by the method of claim 1, wherein the multilayer microporous membrane is optionally a dry process multilayer microporous membrane.

45. An improved multilayer microporous membrane having at least one, two, three, four, five, six, seven, eight, nine, ten, eleven, twelve, thirteen or fourteen of the following properties or features:
a) a JIS Gurley between 50 and 400, between 100 and 400, between 150 and 400, between 100 and 300, or preferably between 100 and 200;
b) a puncture strength between 150 gf and 600 gf, between 300 gf and 600 gf, between 320 gf and 600 gf, more preferably between 380 gf and 600 gf, and most preferably between 400 gf and 600 gf or more;
c) an MD strength above 500 kg/cm², above 600 kg/cm², above 700 kg/cm² and preferably above 1,000 kg/cm²;
d) A TD strength above 300 kg/cm², above 350 kg/cm², preferably above 500 kg/cm², and most preferably above 600 kg/cm²;
e) an MD elongation preferably equal to or above 30%, equal to or above 40%, equal to above 50%, or more preferably above 100%;
f) a TD elongation preferably equal to or above 30%, or 40%, or 50%, or 60% or more preferably equal to or above 70%;
g) an MD shrinkage at least one of 105° C., 120° C., 130° C., or 140° C. that is below 25%, more preferably below 20%, even more preferably below 15%; and most preferably 10% or less;
h) a TD shrinkage at least one of 105° C., 120° C., 130° C., or 140° C. that is below 15%, preferably below 10%, and most preferably below 5%;
i) reduced splittiness;
j) good uniformity, and as a result, a higher minimum dielectric breakdown value;
k) a thickness of 25 microns or less, preferably 20 microns or less, most preferably 15 microns or less;
l) The moisture content is less than 1000 ppm, less than 900 ppm, less than 800 ppm, less than 700 ppm, less than 600 ppm, less than 400 ppm, less than 300 ppm, and most preferably less than 200 ppm.
m) at least one layer of the multilayer micro porous membrane having a TD strength above 300 kg/cm², above 350 kg/cm², preferably above 500 kg/cm², and most preferably above 600 kg/cm² and the layer also having a TD shrinkage at least one of 105° C., 120° C., 130° C., or 140° C. that is below 15%, preferably below 10%, and most preferably below 5%, and
n) at least one layer of the multilayer micro porous membrane having a shutdown temperature less than 160° C., preferably less than 150 ° C., or more preferably less than 140 ° C., most preferably less than 135 ° C.

46. (canceled)

47. (canceled)

48. The battery separator comprising at least one of the membranes of claim 45, wherein:
at least one of the membranes may be uncoated;
at least one of the membranes is coated on one or two sides thereof;
at least one of the membranes is coated on two sides that are opposite to one another;
at least one of the membranes is coated on only one side thereof; or
at least one of the membranes is not coated with a ceramic coating.

49. (canceled)

50. (canceled)

51. (canceled)

52. A secondary lithium ion battery or cell, a composite, or a vehicle or device comprising the separator of claim 48.

53. (canceled)

54. (canceled)

55. (canceled)

56. (canceled)

57. (canceled)

58. (canceled)

59. (canceled)

60. (canceled)

61. (canceled)

62. (canceled)

63. A multilayer microporous membrane formed by the method of claim 1 and wherein the membrane may optionally be one or more of the following: calendered then coated (or treated); coated then calendered; or calendered, coated, and then calendered again.

64. (canceled)
